(19) United States
(12) Patent Application Publication
(10) Pub. No.: US 2023/0172110 A1
(43) Pub. Date: Jun. 8, 2023

(54) Draper Head with a Center Draper Belt Frame

(71) Applicant: Carl Geringhoff GmbH & Co. KG, Ahlen (DE)

(72) Inventors: Steffen Sudhues, Ahlen (DE); Christoph Hartmann, Ennigerloh (DE); Alexander Heitkamp, Dulmen (DE); Dirk Webermann, Senden (DE)

(21) Appl. No.: 17/994,064

(22) Filed: Nov. 25, 2022

(30) Foreign Application Priority Data
Dec. 3, 2021 (DE) 10 2021 131 962.5

(51) Int. Cl. A01D 57/20; A01D 41/14

(52) U.S. Cl. CPC A01D 57/20; A01D 41/14

(57) ABSTRACT

A draper head has a draper head frame and an attachment frame for connection to a feeder housing of a harvester. The draper head frame is connected to swing arms facing in working direction and having front ends movable vertically. The front ends of the swing arms are connected to a blade angle section provided with cutting elements. A center draper belt frame is pivotably arranged at the draper head frame and has a center draper belt disposed thereat. Transverse conveyor belts convey crop transversely to the working direction to the center draper belt which conveys crop rearwardly toward a discharge opening of the draper head. A rotary conveyor is arranged upstream of the discharge opening for conveying the crop toward the discharge opening. A rotation axis of a rearward shaft of the center draper belt and a rotation axis of the center draper belt frame are concentrically arranged.

### BACKGROUND OF THE INVENTION

The present invention relates to a draper head for attachment to a harvester, comprising a draper head frame extending at least substantially across the working width of the draper head and comprising an attachment frame with attachment means for connection to a feeder housing of a harvester, wherein the draper head frame is connected to swing arms facing in working direction and moveable at their front end in vertical direction, the front ends of the swing arms each are connected by a connection component to a blade angle section to which the cutting elements of the draper head are attached; belt conveyor devices of which transverse conveyor belts convey the cut crop placed thereon transversely to the working direction to a center draper belt which conveys the crop placed thereon to the rear in the direction toward a discharge opening located in the rear wall of the draper head; and a rotary conveyor arranged upstream of the discharge opening which conveys, by undershot conveyance, the crop conveyed by the center draper belt in the direction toward the discharge opening.

A draper head of the aforementioned kind is known from the publication US 2022/0338415 A1. Due to the pivotable swing arms and the cutting elements attached thereto at their front side and entrained by the pivot movements of the swing arms, the draper heads of the aforementioned kind can adapt very flexibly to an uneven ground contour during harvest. The belt conveyors also move with the upward and downward movements of the swing arms. In case of the transverse conveyor belts, this has no effects on their conveying behavior. However, disadvantageous effects on the conveying behavior due to the up and down movement result in case of the center draper belt. Indeed, the frame at which the center draper belt is secured is held in a pivot axis stationary in relation to the rotary conveyor. However, since the rotation axis of the rearward shaft of the center draper belt is arranged displaced in relation to the pivot axis of the center draper belt frame, the distance measurement changes between the upper run of the circulating conveyor belt and the rotary conveyor as well as in relation to the opposed surfaces below the rotary conveyor and behind the deflection roller when the center draper belt frame carries out movements in the vertical direction. The interaction of the rotary conveyor with the center draper belt changes also as a result of this. The conveying action of the rotary conveyor on the crop and the transfer of the crop to the discharge opening fluctuate. A non-uniform crop flow can have a disadvantageous effect on the further processing of the crop in the harvester.

It is the object of the present invention to improve the conveyance of the crop in the region of the center draper belt and of the rotary conveyor.

### SUMMARY OF THE INVENTION

The object is solved for a draper head of the aforementioned kind in that the rotation axes of the rearward shaft of the center draper belt and of the center draper belt frame are arranged concentrically to each other.

Due to the concentric arrangement of the rotation axes of the rearward shaft of the center draper belt and of the center draper belt frame, there is no spatial displacement anymore between the rotation axis of the rearward shaft of the center draper belt and the rotation axis of the rotary conveyor. Lacking a spatial displacement, the distance measurements between the upper run of the circulating conveyor belt and the rotary conveyor as well as in relation to the opposed surfaces located below the rotary conveyor and behind the deflection roller remain the same, at least in the region of action of the rotary conveyor, when the front end of the center draper belt carries out upward and downward movements. Thus, the interaction of the rotary conveyor with the center draper belt during the course of the harvest remains the same even when the center draper belt frame carries out significant upward and downward movements. The crop flow from the draper head into the harvester is thus made more uniform. The concentric arrangement of the rotation axes does not mean that they must be only precisely concentrically arranged. For an only minimal displacement of the rotation axes relative to each other, which is present, for example, for a displacement of up to 3 cm or up to 5 cm, the distance measurement between the upper run of the center draper belt and the rotary conveyor changes only so minimally that no negative effect on the conveyance of the crop away from the draper head is to be feared.

When in this description “front” or a “front end” of a component is mentioned, this means the orientation or the side of a component that is located at the side which is facing in the working direction of the draper head. The working direction of the draper head is the direction in which it is moved into the standing crop for harvesting a crop. “Rear” or “rearward end” means the direction or the side of the component that is opposite the working direction.

According to an embodiment of the invention, the center draper belt frame is resting at its front end on the blade angle section without being fixedly connected to the blade angle section.

The blade angle section is the section at which the cutter bar is fastened. It extends in the front region of the draper head across the working width of the draper head. It can be of a one-part configuration or can be divided into several segments which extend across the working width of the draper head. Providing segments of the blade angle section can be realized such that a segment bridges the intermediate space between two neighboring swing arms and that its segment ends are connected to the swing arms. The cutter bar is supported by one or a plurality of blade angle sections and is connected thereto preferably by a screw connection. In the region of the center draper belt, the blade angle section can serve additionally as attachment for the blade drive gear. The blade angle section moves upwardly and downwardly together with the swing arms during the harvesting operation.

Due to the loose contact of the center draper belt frame on the blade angle section, the center draper belt frame can freely move, following the ground contour, by means of pivot movements of the swing arms. This applies even when the rotation axes of the swing arms are not concentric to the rotation axes of the rearward shaft of the center draper belt and of the center draper belt frame. The movability of the blade angle section with the cutting elements attached thereto is not impeded by the loosely contacting center draper belt frame. Since the center draper belt frame is resting with its weight on the blade angle section, it however follows the upwardly and downwardly oriented movements of the blade angle section so that they always move in the same direction without this requiring a separate drive means. Larger height differences between the blade angle section and the front end of the center draper belt frame are thus avoided. The swing arms in this context can be configured as leaf springs or rigid guides supported rotatably about a rotation axis. The compression and rebound movements of the swing arms are transmitted through the blade angle section to the center draper belt frame. The blade angle section synchronizes in this manner the upward and downward movements of the swing arms and of the center draper belt frame.

When the blade angle section is mentioned in this context, this term also represents all components at the front side of the draper head that are fixedly connected to the blade angle section and move together therewith upwardly and downwardly during harvesting operation of the draper belt. For example, this can also be transmission casings of blade drives and other components.

According to an embodiment of the invention, the center draper belt frame is resting at its front end on the blade angle section without being fixedly connected to the blade angle section. In this manner, following the movement of the swing arms, the center draper belt frame can move at its front end upwardly and downwardly, without this leading to tensions in relation to the blade angle section. In this context, the center draper belt frame can rest with the bottom side of a component on a top side of a component of the blade angle section and can glide thereon.

According to an embodiment of the invention, the intermediate space between the blade angle section and the upper run of the center draper belt is bridged by a mat of a flexible material. As far as height differences between the blade angle section and the center draper belt frame are caused by the upward and downward movements of the blade angle section on an uneven ground and the distance between the front end of the center draper belt frame and the blade angle section changes, these changes are compensated by the flexible mat. Possible harvest losses which could occur otherwise in the transition region from blade angle section to the center draper belt frame are avoided by the flexible mat. Possible gaps and interstices that could open or enlarge due to the constant relative movements between the blade angle section and the center draper belt frame are covered by the flexible mat from above so that no crop can fall to the ground in this transition region. Due to the flexible properties of the material used for the mat, for example, rubber or another elastic plastic material, the shape of the mat constantly adjusts to the respective requirements.

According to an embodiment of the invention, the draper head comprises a frame section that is configured to be connected fixedly to a harvester; an intermediate frame is connected to the frame section and, by means of an adjustment drive, is rotatable about an axis which is oriented transversely to the working direction; and at least one of the swing arms is connected to the intermediate frame. The intermediate frame serves the purpose of being able to change, as needed, the angle of attack of the draper head in relation to the ground. Depending on the crop and/or harvest situation, it can be advantageous to operate the belt conveyors and the cutting elements at a flatter angle in relation to the ground in order to avoid crop losses, or to improve the crop pick-up and conveyance by a steeper angle of attack. By means of the adjustment drive which is acting on the intermediate frame, the angle of attack of the draper head in relation to the ground can be adjusted to a desired value. When together with the intermediate frame the swing arm attached thereto is also adjusted, the latter entrains mandatorily also the center draper belt frame which is connected to it into a corresponding position. In this manner, the center draper belt frame can be moved mandatorily also into an angle of attack in relation to the ground that matches the angle of attack at which the swing arm is held in relation to the ground. A separate adjustment device is not required for this anymore. The intermediate frame can be embodied as two separate partial frames and each partial frame adjusts the angle of attack for a draper head side. The adjustment movement of the two partial frames can then be synchronized by the respective drives so that the draper head parts are adjusted always at the same angle of attack in relation to the ground.

According to an embodiment of the invention, the center draper belt frame is connected at its front end by a slotted link guide to neighboring swing arms.

The center draper belt frame is supported by means of the connection to the swing arms. The slotted link guide compensates length differences between the center draper belt frame and the correlated swing arm which occur in case of movements at the connection location and enables the correlated swing arm to continue to perform upward and downward movements in order to adapt as precisely as possible to the ground contour. In this context, the slotted link guide however also entrains the center draper belt frame. It couples the mobility of the center draper belt frame to the movements of the correlated swing arm and limits the mobility of the center draper belt frame in this way. Differences between the correlated swing arm and the center draper belt frame in regard to the movement direction and the movement speed are thereby avoided. It makes no difference for the mobility of the correlated swing arm and of the center draper belt frame whether the slotted link guide is fixedly connected to the swing arm or to the center draper belt frame and the connection part which is guided in the slotted link guide is fixedly connected to the respective other component.

According to an embodiment of the invention, the swing arms, which are connected to the center draper belt frame, support deflection rollers for transverse conveyor belts and are connected to the blade angle section. The swing arms coordinate in this manner the height adaptation of the center draper belt frame, of the discharge side of the transverse conveyor belts, and of the blade angle section with the cutting elements attached thereto relative to each other. All of the aforementioned components move via the swing arm synchronously to each other with the same speed in the same direction.

Disturbances in the crop flow of the crop that are possible without such a coordination as well as possible crop losses are avoided in this way.

According to an embodiment of the invention, the center draper belt frame comprises a bottom door that seals the installation space, in which the lower run of the center draper belt runs toward the front, in downward direction. The bottom door catches crop that falls downwardly behind the rearward deflection roller or is entrained by the center draper belt downwardly. In order to prevent that this crop falls to the ground as loss, the bottom door serves as a catching surface on which the crop that has moved below the center draper belt can collect. From here, it is routinely moved by the lower run moving in working direction of the draper head to the front and conveyed about the front belt deflection roller opposite to the working direction of the draper head onto the upper run. Crop or contaminants that have not been conveyed in this manner can be removed occasionally in that the bottom door is opened and the material that is located thereat is removed. In order to be able to easily open the bottom door, it is possible that the rotation axis about which the bottom door is rotatable is arranged concentric to the rotation axes of the rearward shaft of the center draper belt and of the center draper belt frame. The bottom door opens then forwardly in working direction so that the crop that has collected on the bottom door can be easily removed.

It is expressly noted that the afore described embodiments of the invention taken alone, respectively, but also in arbitrary combinations with each other can be combined with the subject matter of the independent claim insofar as no technically forced obstacles stand in the way.

Further modifications and embodiments of the invention can be taken from the following subject matter description and the drawings.

### BRIEF DESCRIPTION OF THE DRAWINGS

The invention will now be explained in more detail with the aid of embodiments.

FIG. 1 shows a view of a harvester with draper head at a slant from the front.

FIG. 2 shows a view of a draper head from the rear.

FIG. 3 shows a view of a draper head viewed at a slant from the front and from above.

FIG. 4 shows a partial view of a draper head at a slant from the front.

FIG. 5 shows a section view of the center draper belt in the draper head.

FIG. 6 shows a side view of the center draper belt frame.

FIG. 7 shows a frame section of the draper head.

### DESCRIPTION OF PREFERRED EMBODIMENTS

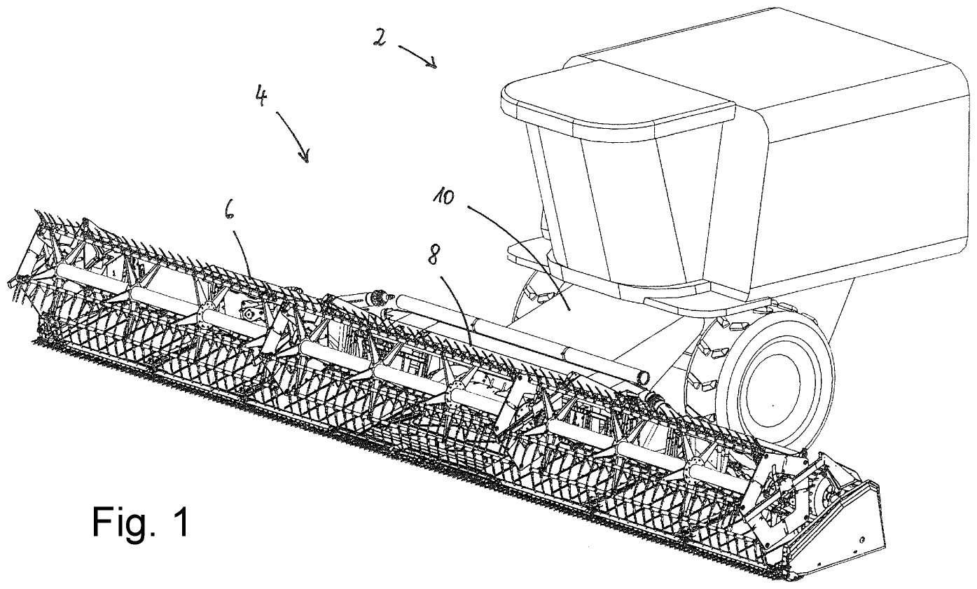

In FIG. 1, a view of a harvester 2 with a draper head 4 is illustrated at a slant from the front. The draper head 4 comprises a draper head frame 6 that is connected by an attachment frame 8 to the feeder housing 10 of the harvester 2.

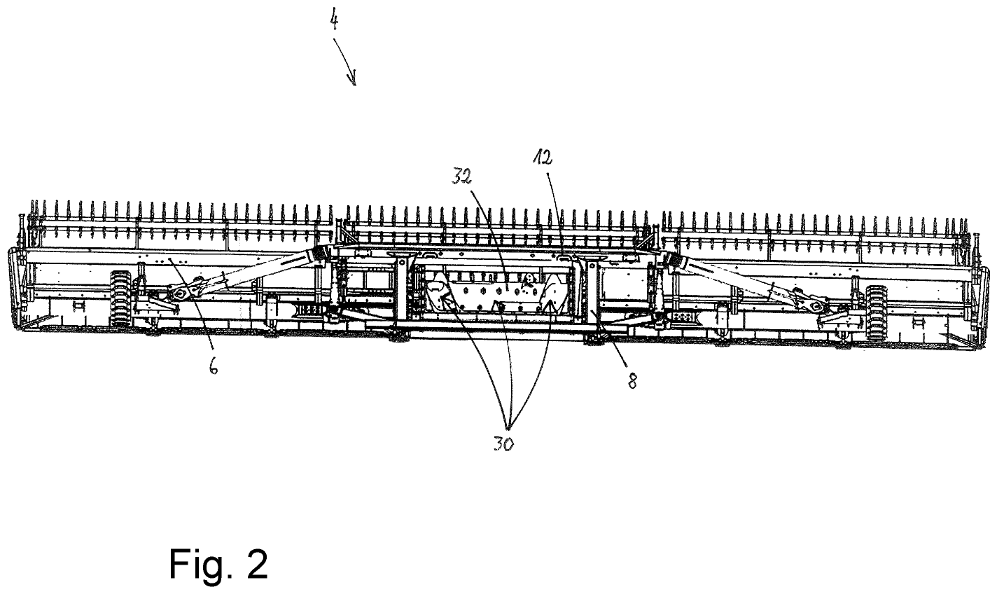

In the view of the draper head 4 from the rear illustrated in FIG. 2, it can be seen that attachment means 12 such as, for example, catch hooks, by means of which the draper head 4 can be connected to the harvester 2 are arranged at the attachment frame 8. In the view from the rear, the discharge opening 30 through which the crop is discharged to the feeder housing 10 of the harvester 2 can be seen well. Also, the rotary conveyor 32 which is arranged in conveying direction upstream of the discharge opening 30 can be seen well. The rotary conveyor 32 conveys by undershot conveyance the crop conveyed by the center draper belt 28 in the direction toward the discharge opening 30.

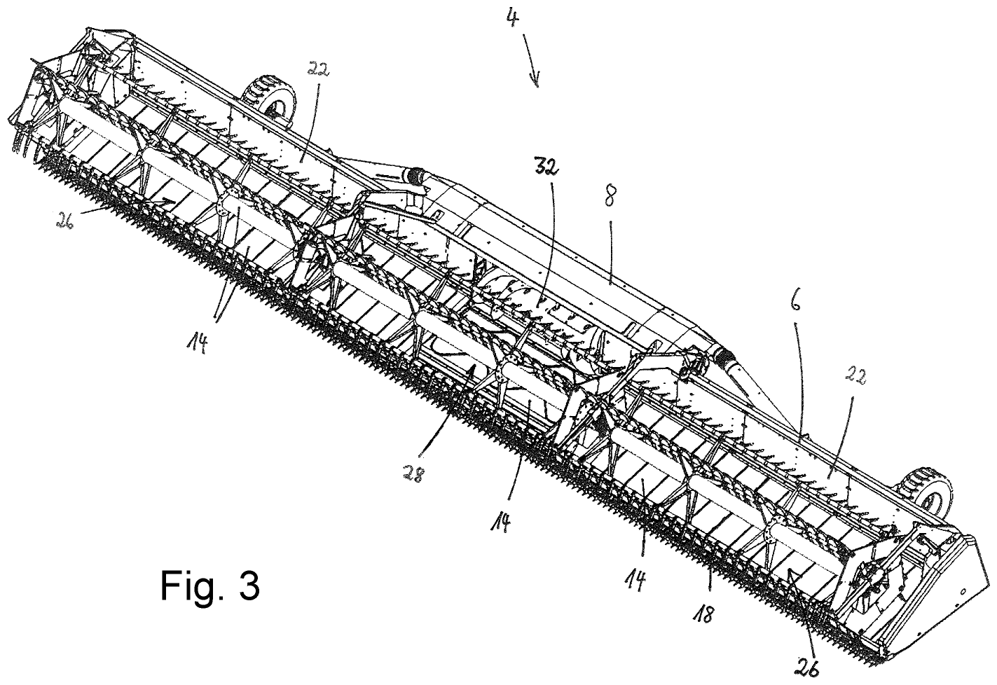

In FIG. 3, a view of a draper head 4 in a view at a slant from the front and from above is illustrated. In this view, it can be seen that the draper head 4 comprises a number of conveying members 14. Some of the conveying members 14 are endless circulating belt conveyor devices 26, 28 of which the transverse conveyor belts 26 transport the cut crop placed thereon transverse to the working direction to a center draper belt 28 which conveys the crop placed thereon to the rear in the direction toward the discharge opening 30 which is located in the rear wall 22 of the draper head 4. Shortly before the point of transfer of the crop to the feeder housing 10 of the harvester 2, the rotary conveyor 32 assists in crop transfer. Above the bottom-side conveying members 14, a reel as a further conveying member 14 is provided which, upon rotational movement, engages the standing crop with the reel fingers and the rods at which the reel fingers are fastened, supports the crop while the stems are cut close to the ground, and places the stems after the cut onto the bottom-side conveying members.

At the front side of the draper head 4, a cutting element 18 in the form of a cutter bar is provided. The cutter bar is driven in oscillation transversely to the working direction in order to cut the crop at its stalks or stems. The cutter bar can be embodied as a multi-part structure and can comprise a plurality of drive paths. Depending on the crop and its condition, it is desirable to guide the cutting element 18 as close as possible to the ground in order to avoid crop losses. For example, in case of soy, it is necessary to cut the stems very close to the ground in order to avoid loss of soybeans. Likewise, in case of laid grains, it is advantageous to cut as close as possible to the ground in order to also avoid crop losses here. For a high straw yield, it is also advantageous to cut as close as possible to the ground.

The cut crop is then conveyed by the conveying members 14 along the rear wall 22 of the draper head 4. The rear wall 22 is embodied closed in respect to the conveying members 14 in order to also avoid crop losses here.

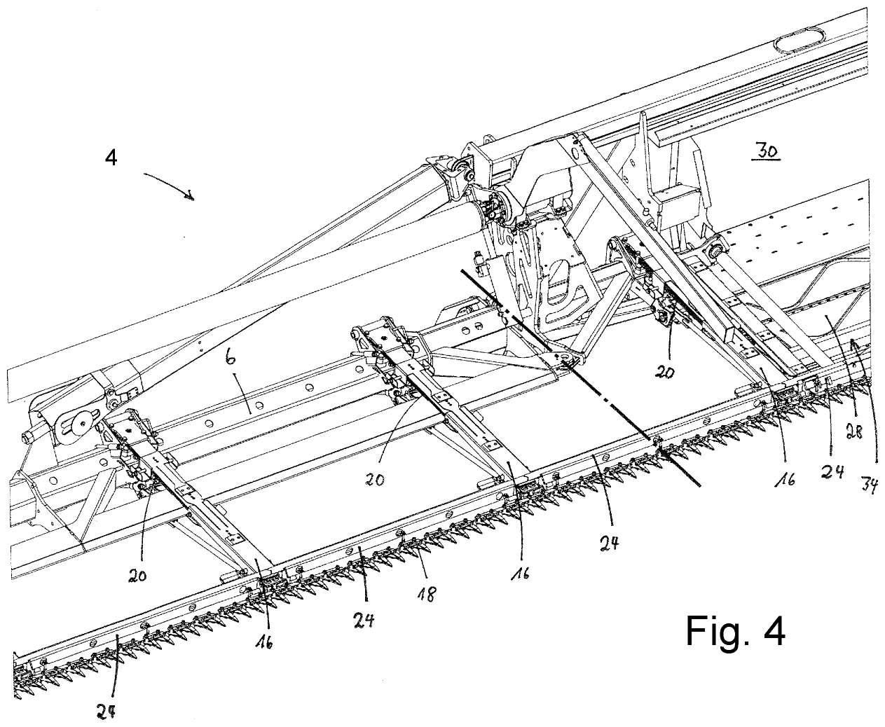

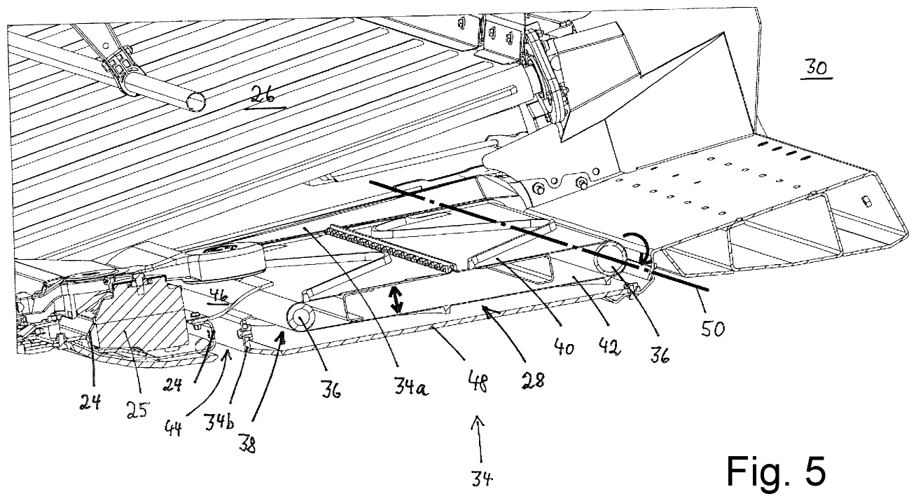

FIG. 4 shows a partial view of a draper head at a slant from the front. The transverse conveyor belts 26, the rear wall 22, and the reel have been omitted in this view. One can see well the center draper belt 28, the discharge opening 30, and the draper head frame 6 with swing arms 16 which are fastened thereto, face in working direction, and are movable at their front end in vertical direction. The center draper belt 28 is held at a center draper belt frame 34 and circulates thereat about shafts 36 arranged at the ends and illustrated in FIG. 5. The front ends of the swing arms 16 are each connected by a connection component to a blade angle section 24 at which the cutting elements 18 of the draper head 4 are fastened. The swing arms 16 are comprised of leaf spring packs 20 in the embodiment and can swing at their free front ends upwardly and downwardly in vertical direction when the blade angle section 24 rests on the ground and the ground contour changes.

FIG. 5 shows a section view of the center draper belt 28 in the draper head 4. In the illustrated view, a longitudinal support 34a extending in length direction and a transverse support 34b of the center draper belt frame 34 extending in a direction transverse to the working direction of the draper head can be seen. About the front and rear shafts 36, the center draper belt 28 is wrapped whose running direction is indicated by the curved arrow. The crop is conveyed on the upper run 40 to the rear in the direction of the discharge opening 30. The center draper belt 28 runs around the rearward shaft 36 at the rearward end of the conveying stretch and then runs with the lower run 42 toward the front again. Since the center draper belt frame 34 is supported pivotably about the rotation axis 50 of the rearward shaft 36, the center draper belt frame 34 at its front end 38 can pivot up and down in accordance with the double arrow. The blade drive 25 is attached to the blade angle section 24.

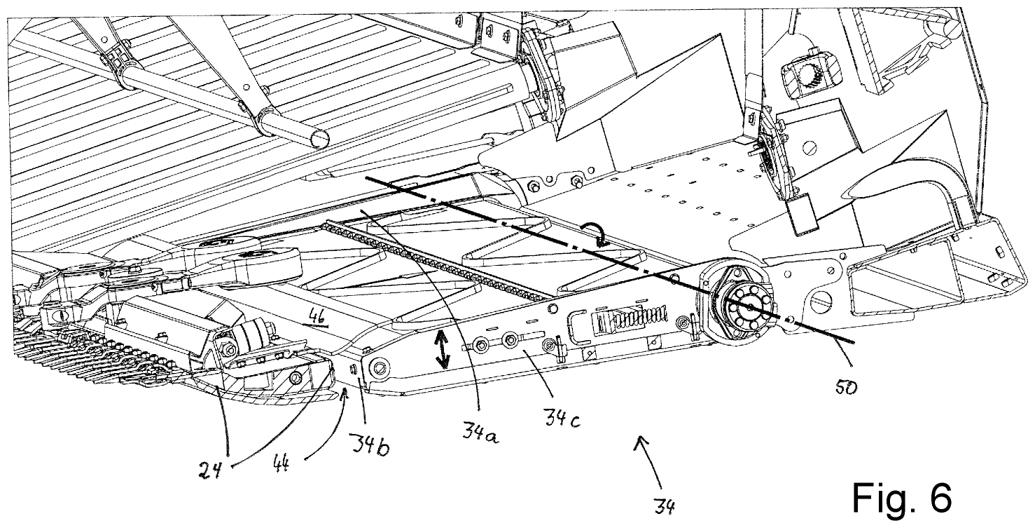

In FIGS. 5 and 6, the intermediate space 44 between the front end 38 of the center draper belt frame 34 and the rearward end of the blade angle section 24 is visible. The intermediate space at its upper end is covered by the flexible mat 46. The center draper belt frame 34 comprises a bottom door 48 which seals in downward direction the installation space in which the lower run 42 of the center draper belt 28 runs to the front.

In FIG. 6, a side view of the center draper belt frame 34 is illustrated. In the side view, the longitudinal support 34c is illustrated from the side. In the side view, it can be seen that the center draper belt frame 34 is also pivotable about the rotation axis 50 about which the rearward shaft 36 of the center draper belt 28 rotates. The rotation axes 50 of the rearward shaft 36 of the center draper belt 28 and of the center draper belt frame 34 are thus concentrically arranged relative to each other.

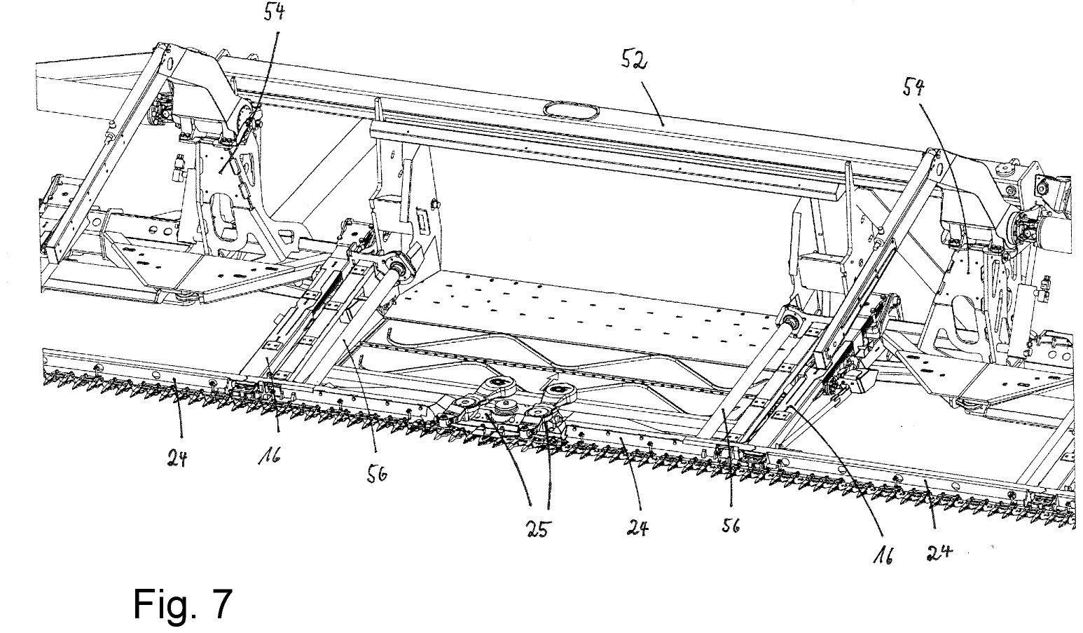

In FIG. 7, the frame section 52 of the draper head 4 is illustrated that is configured to be connected fixedly to a harvester 2. An intermediate frame 54 is connected to the frame section 52 and is rotatable by an adjustment drive about an axis which is oriented transversely to the working direction. At least one of the swing arms 16 is fastened to the intermediate frame 54. The swing arms 16 can be connected to the center draper belt frame 34 by a slotted link guide. The deflection rollers 56 of the transverse conveyor belts 26 are supported at their rearward ends at the intermediate frame 54. In the embodiment illustrated in FIG. 7, the front ends of the deflection rollers 56 are supported on the blade angle section 24. As an alternative, it is possible to support them on a neighboring swing arm 16, respectively.

The invention is not limited to the afore described embodiment. A person of skill in the art will have no difficulty in modifying the embodiment with use of his knowledge in the art in order to adapt it in a manner appearing suitable to him to a concrete application situation without thereby deviating from the teachings of the invention.

The specification incorporates by reference the entire disclosure of German priority document 10 2021 131 962.5 having a filing date of 3 Dec. 2021.

While specific embodiments of the invention have been shown and described in detail to illustrate the inventive principles, it will be understood that the invention may be embodied otherwise without departing from such principles.

### LIST OF REFERENCE CHARACTERS

2 harvester
4 draper head
6 draper head frame
8 attachment frame
10 feeder housing
12 attachment means
14 conveying member
16 swing arm
18 cutting element (cutter bar)
20 leaf spring pack
22 rear wall
24 blade angle section
25 blade drive
26 transverse conveyor belt
28 center draper belt
30 discharge opening
32 rotary conveyor
34 center draper belt frame
34a longitudinal support
34b transverse support
34c longitudinal support
36 shaft
38 front end
40 upper run
42 lower run
44 intermediate space
46 mat
48 bottom door
50 rotation axis
52 frame section
54 intermediate frame
56 deflection roller

What is claimed is:

1. A draper head for attachment to a harvester, the draper head comprising:
a draper head frame extending at least substantially across a working width of the draper head and comprising an attachment frame with attachment elements configured to connect to a feeder housing of the harvester;
swing arms facing in a working direction of the harvester, wherein the draper head frame is connected to the swing arms, and wherein the swing arms comprise front ends movable in a vertical direction;
a blade angle section and cutting elements fastened to the blade angle section, wherein the front ends of the swing arms are connected to the blade angle section;
a center draper belt frame arranged at the draper head frame so as to be pivotable about a first rotation axis;
a center draper belt disposed at the center draper belt frame;
transverse conveyor belts configured to convey cut crop placed thereon transversely to the working direction to the center draper belt, wherein the center draper belt is configured to convey the crop placed thereon opposite to the working direction rearwardly toward a discharge opening located in a rear wall of the draper head;
a rotary conveyor arranged upstream of the discharge opening and configured to convey the crop, conveyed on the center draper belt, by undershot conveyance toward the discharge opening;
wherein a rearward shaft of the center draper belt has a second rotation axis;
wherein the first rotation axis of the center draper belt frame and the second rotation axis of the rearward shaft of the center draper belt are arranged concentrically to each other.

2. The draper head according to claim 1, wherein the center draper belt frame has a front end resting on the blade angle section without being fixedly connected to the blade angle section.

3. The draper head according to claim 1, further comprising a mat of flexible material, wherein the mat of flexible material bridges an intermediate space between the blade angle section and an upper run of the center draper belt.

4. The draper head according to claim 1, further comprising:
a frame section configured to connect fixedly to the harvester;
an intermediate frame connected to the frame section and rotatable by an adjustment drive about an axis oriented transversely to the working direction, wherein at least one of the swing arms is fastened to the intermediate frame.

5. The draper head according to claim 1, wherein the swing arms include neighboring swing arms neighboring the center draper belt frame, wherein the center draper belt frame comprises a front end connected by a slotted link guide to the neighboring swing arms.

6. The draper head according to claim 5, wherein the neighboring swing arms are connected to the blade angle section and support deflection rollers of the transverse belt conveyors.

7. The draper head according to claim 1, wherein the center draper belt frame comprises a bottom door which seals in a downward direction an installation space in which a lower run of the center draper belt runs from the rearward shaft in the working direction toward a front end of the draper head.
